(19) United States
(12) Patent Application Publication
(10) Pub. No.: US 2026/0236866 A1
(43) Pub. Date: Aug. 13, 2026

(54) SYSTEMS AND METHODS FOR USING GENERATIVE AI MODELS TO PRODUCE AUTOMATION PROGRAMS AND PROCESSES

(71) Applicant: Automation Anywhere, Inc., San Jose, CA (US)

(72) Inventors: Bart Stefan Loos, Pleasant Hill, CA (US); Chee-wai Chan, Glen Head, NY (US); Pratyush Garikapati, Fremont, CA (US)

(73) Assignee: Automation Anywhere, Inc., San Jose, CA (US)

(21) Appl. No.: 19/411,324

(22) Filed: Dec. 7, 2025

Related U.S. Application Data
(63) Continuation-in-part of application No. 19/034,538, filed on Jan. 22, 2025.
(60) Provisional application No. 63/627,077, filed on Jan. 31, 2024.

(51) Int. Cl. G06Q 10/0631

(52) U.S. Cl. CPC G06Q 10/06316

(57) ABSTRACT

Systems and methods for producing automation programs suitable for performing business and/or personal tasks using software application programs. The methods and systems involve can identify or receive a user request for the production of an automation program and then utilize one or more generative AI models to produce an automation program. In one embodiment, a user-requested automation program can be produced with the assistance of trained Large Language Models (LLMs). For example, one LLM can be used to identify one or more automation packages from a plurality of automation packages available for user with a robotic process automation system, and another LLM can be used to produce an automation plan for the requested automation program. The automation plan can serve as a template for a requested automation program. In another embodiment, different generative AI models can produce different aspects of the requested automation program.

### CROSS-REFERENCE TO RELATED APPLICATIONS

This application is a continuation-in-part of U.S. patent application Ser. No. 19/034,538, filed Jan. 22, 2025, and entitled “SYSTEMS AND METHODS FOR USING MACHINE LEARNING MODELS TO PRODUCE AUTOMATION PROGRAMS AND PROCESSES,” which is hereby incorporated by reference herein, and which in turn claims priority to U.S. Provisional Patent Application No. 63/627,077, filed Jan. 31, 2024, and entitled “SYSTEMS AND METHODS FOR USING MACHINE LEARNING MODELS TO PRODUCE AUTOMATION PROGRAMS AND PROCESSES,” which is hereby incorporated by reference herein.

### BACKGROUND OF THE INVENTION

Process automation systems enable automation of repetitive and manually intensive computer-based tasks. In an automation system, automation programs can be created to perform tasks that would otherwise be performed by humans. Some automation programs have the capability of mimicking the actions of a person in order to perform various computer-based tasks. For instance, an automation system can interact with one or more software applications through user interfaces, as a person would do. Such automation systems typically do not need to be integrated with existing software applications at a programming level, thereby eliminating the difficulties inherent to integration. Advantageously, automation systems permit automation of application-level repetitive tasks via automation programs that are coded to repeatedly and accurately perform the repetitive tasks.

Automation programs can be created by individuals of various levels of software development experience. Low code software development systems might be available to allow those with lesser levels of software development experience create automation programs. However, even with such assistance, creating automation programs still requires substantial time, effort, and at times, at least a moderate level of development experience. Therefore, there is a need for improved systems and method to produce automation programs for use by process automation systems.

### SUMMARY

Systems and methods for producing automation programs that are suitable for performing business and/or personal tasks using software application programs are disclosed.

In one embodiment, the systems and methods can, for example, assist a user in producing a software automation process for use with a robotic process automation system. One implementation can, for example, operate to at least: receive a user request specifying a desired software automation process (e.g., in a natural language format); select, with the assistance of a first trained Large Language Model (LLM) and based on the user request, one or more automation packages from a plurality of automation packages available for user with a robotic process automation system; extract actions or conditions from the selected one or more automation packages; and produce, with the assistance of a second trained LLM, an automation plan for the desired software automation process. The automation plan can specify a series of steps, and one or more of the steps can make use of at least one of the extracted actions or conditions. The automation plan being produced can be a template for the desired software automation process. The template is able to be thereafter finalized to produce the desired software automation process. Alternatively, the automation plan can be the desired software automation process.

In another embodiment, the systems and methods can, for example, involve identifying or receiving a user request for the production of an automation program and then utilizing one or more generative Artificial Intelligence (AI) models. Each of the generative AI models can produce an aspect of the requested automation program. Each of the generative AI models can also be provided with inputs such as a specific user's request for an automation program to automate tasks, the definition of a role that the model should take on, domain knowledge specific to an aspect of the automation program being requested, and functional instructions for each of the generative AI models to produce a desired output. The outputs of each of the generative AI models can be combined to form the user-requested automation program.

Advantageously, automation of processes, such as enterprise-level business and/or personal processes, by automation systems can produce automation programs based on user requests so that the development of automation programs can be accelerated through automation and thus users need not spend so much time and effort on producing such automation programs.

The invention can be implemented in numerous ways, including as a method, system, device, or apparatus (including computer readable medium). Several embodiments of the invention are discussed below.

As an automation production system for producing a software automation process for use with the robotic process automation system, one embodiment can, for example, include at least: an input user interface configured to be presented to a user and to receive a user request specifying a desired software automation process in a natural language format; an automation package selection engine configured to use a first trained LLM to select, based on the user request, one or more automation packages from a plurality of automation packages available for user with the robotic process automation system; an extraction engine configured to extract actions, conditions and/r iterators from the selected one or more automation packages; and an automation planning engine configured to use a second trained LLM to produce an automation plan for the desired software automation process.

As a computer-implemented method for producing a software automation process for use with a robotic process automation system, one embodiment can, for example, include at least: receiving, by an automation production system, a user request specifying a desired software automation process in a natural language format; selecting, with the assistance of a first trained LLM and based on the user request, one or more automation packages from a plurality of automation packages available for user with the robotic process automation system; extracting actions and/or conditions from the selected one or more automation packages; and producing, with the assistance of a second trained LLM, an automation plan for the desired software automation process, the automation plan specifies a series of steps, and one or more of the steps utilizing at least one of the extracted actions, and one or more of the steps utilizing at least one of the extracted conditions.

As a non-transitory computer readable medium including at least computer program code tangible stored therein for producing a software automation process for use with a robotic process automation system, one embodiment can, for example, include at least: computer program code for receiving a user request specifying a desired software automation process in a natural language format; computer program code for selecting, with the assistance of a first trained LLM and based on the user request, one or more automation packages from a plurality of automation packages available for user with the robotic process automation system; computer program code for identifying actions and conditions supported by the selected one or more automation packages; and computer program code for producing, with the assistance of a second trained LLM, an automation plan for the desired software automation process, the automation plan specifies a series of steps, and one or more of the steps utilizing at least one of the identified actions, and one or more of the steps utilizing at least one of the identified conditions.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of an automation environment according to one embodiment.

FIG. 2 is a diagram of a process flow for producing automaton programs according to one embodiment.

FIG. 3 is a diagram of a process flow for producing automaton programs according to another embodiment.

FIG. 4 illustrates a portion of a spreadsheet version of domain knowledge to be provided to a command package model, according to one embodiment.

FIG. 5 is a flow diagram for utilizing models within a generative AI model system in which an orchestrator model can set affirmative model triggers, according to another embodiment.

FIG. 6A illustrates an exemplary automation system user interface that includes a chat box interface where a user can enter an automation program request as well as an automation editor workspace.

FIG. 6B illustrates another exemplary automation system user interface that includes a chat box interface where a user can enter an automation program request.

FIG. 7A is a block diagram of an automation generation system according to one embodiment.

FIG. 7B is a flow diagram of an automation plan process according to one embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Systems and methods for producing programs and processes for performing business and personal tasks using software application programs are disclosed.

In one embodiment, the systems and methods can involve identifying or receiving a request for production of an automation program and then utilizing one or more Machine Learning (“ML”) models or large language models (“LLMs”, referred herein as models, where each model produces an aspect of the requested automation program. In the case of producing an automation program, various aspects of an automation program can include, but are not limited to, programming commands for performing actions needed to accomplish steps of a process, attributes needed by commands to perform the actions according to desired specifications or parameters, and structure or syntax of automation programs or processes required by an automation or business process platform to execute such a program. These models can produce outputs that combine to form such automation programs or processes that can used directly to perform tasks or can be used after having been updated or revised through a separate process or by a human. Each of the models can be LLMs or machine learning models that are tuned, either by prompt tuning or by fine tuning, to have the capability to produce desired aspects or components of automation programs or processes. In some implementations, tuning of the models can involve providing inputs to the model such as a specific user's request for a program to automate a task, the definition of a role that the model should take on, which helps set the context within which the model should produce its outputs, domain knowledge specific to an aspect of the program requested to be produced, and functional instructions for the model to produce a desired output. The outputs of each of the models can be combined to form the user requested automation program.

In some implementations of the embodiments disclosed herein, the systems and methods disclosed herein advantageously allow a human user of process automation platform to request the platform to automatically produce a program that the process automation platform can use to automate a certain business or personal process or task. This capability shortens the time and effort needed to benefit from the process automation features of the platform, which otherwise cannot be realized until after sometimes lengthy efforts to design and build such automations where such efforts require software programming skills and experience. This is also advantageous since some process automation platforms, while rich in the many features and capabilities they provide, may also be difficult for less technologically savvy users to navigate in order to create their own programs. For example, it may be difficult for such users to identify suitable programming commands, to set variables and attributes, to determine when and how to include programmatic “if” or “loop” commands, etc.

In some implementations of the embodiments disclosed herein, the systems and methods of this disclosure can be used with process automation platforms that include robotic process automation (RPA) capabilities. Generally speaking, RPA systems use computer software to emulate and integrate the actions of a user or person interacting within digital systems. In an enterprise environment, the automation systems are often designed to execute business processes, and most notably to handle high-volume, repeatable tasks that previously required humans to perform. In some cases, the automation systems use AI and/or other machine learning/generative AI technologies to achieve automation as well as to produce automation programs. The automation systems also provide for creation, configuration, management, execution, and/or monitoring of automation processes.

A software automation program (or software automation process) is sometimes referred to as a software robot, software agent, or a bot. Software automation programs can accurately and repeatably perform a task or workflow they are tasked with. As one example, a software automation program can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation program can perform data tasks, such as reformatting, extracting, balancing, error checking, moving, copying, or any other desired tasks. As another example, a software automation program can grab data desired from a webpage, application, screen, file, or other data source. As still another example, a software automation program can be triggered based on time or an event, and can serve to take files or data sets and move them to another location, whether it is to a customer, vendor, application, department or storage. These various capabilities can also be used in any combination.

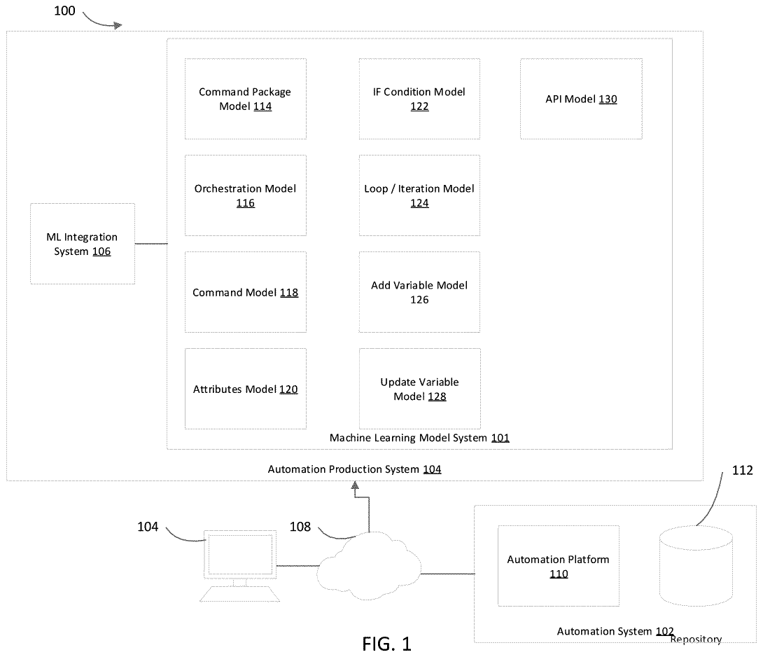

Embodiments of various aspects of the invention are discussed below with reference to FIGS. 1-14. However, those skilled in the art will readily appreciate that the detailed description given herein with respect to these figures is for explanatory purposes as the invention extends beyond these limited embodiments.

FIG. 1 is a block diagram of an automation environment 100 according to one embodiment. The programmatic automation environment 100 is a computing environment that supports the automation of processes.

The automation environment 100 includes systems, devices, and services that include an automation system 102, a client device 104 that allows a user to interact with the automation system 102, an AI model system 101, and an AI learning integration system 106, each of which are interconnected through a network 108 such as the internet, local area networks, wide area networks, and private or public clouds. In other implementations, client device 104 could be locally connected. It should also be understood that multiple client devices 104 could be connected to the other components within automation environment 100. The client device 104 (or multiple client devices) can, for example, be an electronic device having computing capabilities, such as a mobile phone (e.g., smart phone), tablet computer, desktop computer, portable computer, server computer, and the like.

The automation system 102 includes an automation platform 110 and a repository 112. The automation platform 110 provides process automation functionality for automating processes by providing components for creating, editing, executing, and managing automation programs. In some instances, these automation programs (or automation processes) may also be referred to as “software robots,” “bots” or “software bots.”

For example, these automation programs, can interact with one or more software applications that a user uses to perform a business or personal task. These software applications can vary widely with a user's computer system and specific tasks to be performed thereon. For example, the software applications being used might be word processing programs, spreadsheet programs, email programs, ERP programs, CRM programs, web browser programs, any many more. These automation programs may interact with the software applications through graphical user interfaces or Application Programming Interfaces (APIs) of the respective software applications. The repository 112 can store software automation programs, including those created by users of the automation system 102 or by other parties, and various files needed by or related to various features provided by the automation system 102. The automation system 102 is accessed and utilized by a user using a client device 104 that is connected to the automation system 102, such as through the network 108.

The AI model system 101 includes or hosts multiple machine learning or large language models that provide the automation environment 100 with the ability to produce or generate various aspects of automation programs such that collectively the various models are able to produce automation programs that are ready, or are near ready, for execution by the automation system 102. In the shown implementation, the AI model system 101 includes command package model 114 that addresses the aspect of identifying command packages to be used in producing automation program, where command packages include one or more commands to be executed by the automation platform 110 to perform respective tasks. The AI model system 101 also includes an orchestration model 116 that can be used to produce instructions related to the programming aspect of automation program structure and syntax. As will be discussed further below, the AI model system 101 also includes various other models to address other automation program aspects needed to form an automation program as requested by a user. In the shown implementation, the other individual models include a command model 118, an attributes model 120, an IF condition model 122, a loop or iteration model 124, an add variable model 126, an update variable model 128, and an API model 130. Although not shown here, the AI model system 104 may include various additional models for producing other aspects of automation programs.

The AI integration system 106 facilitates integration of the multiple models within AI model system 101. The AI integration system 106 provides a design and execution framework for developing applications that incorporate cognitive or artificial intelligence technologies. Such systems facilitate sharing inputs and outputs between multiple machine learning, large language models, or the like so they can be utilized in combination to achieve system design goals. In some instances, AI integration system 106 can be LangChain. The AI integration system 106 also gathers and provides the various types of information, prompts, tuning prompts to each of the models.

The automation environment 100 and the concepts disclosed herein can also be used to produce process flows, as opposed to automation programs. Process flows refer to sequences of actions and steps taken by automation programs and by humans for the purpose of completing a task or a series of business or personal tasks. As one example, a user may as request the automation environment 100 to produce or suggest a process flow for a corporate process for onboarding a new employee that involves receiving the name, employee number, and other employee identifying information, having an automation program perform the step of sending this information to a human resources (HR) management system, having a human HR manager approve the employee for a certain configuration of computer systems for a work station, and then having the automation program perform the step of sending an action item in the form of an ticket item to instruct the information technology (IT) team to provision the new employee with the selected computer system configuration. As can be seen, this process flow can involve steps taken by both the automation program and a human being.

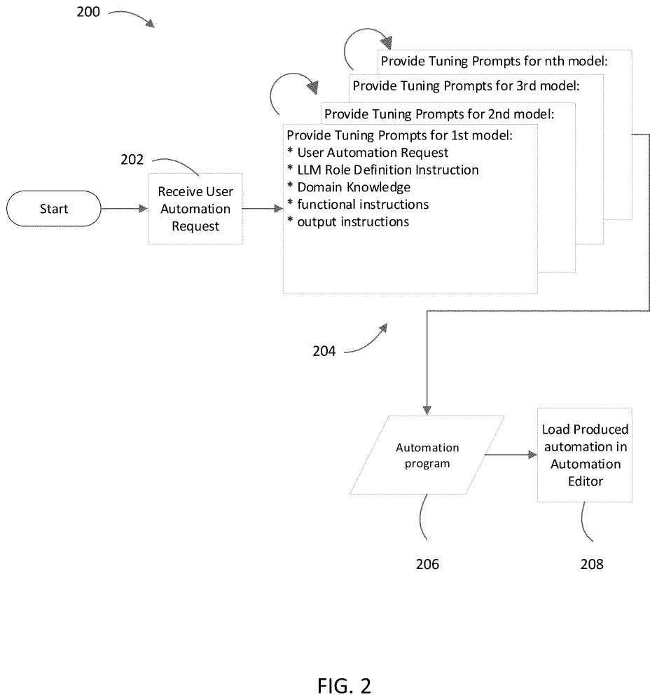

FIG. 2 illustrates a process flow 200 for producing automaton programs according to one embodiment of the systems and methods described herein. This process flow 200 starts when a user of the automation platform 110 receives a user's request, in step 202, for an automation program to perform a specific task or set of tasks. In one example, a user may request an automation program to review multiple invoice documents and to send an email asking for invoice payment approval for any of the invoice documents with total amounts due of over a certain monetary amount. In another example, a user could request an automation program to extract customer mailing addresses from a spreadsheet and to enter the mailing addresses into a customer relationship management (CRM) system. As one could imagine, user requests could vary widely depending on the user's job responsibilities.

Upon receiving the user's request, the automation production system 104, in a series of steps 204, utilizes various of the individual AI models to produce the requested automation program. In producing the requested automation programs, one or more of the generative AI models produce each of the components of the automation program, such components can include but not limited to commands or actions, attributes for such commands, variables, and conditions. In some implementations, the individual models are large language models that have been trained on large amounts of data such that they are suitable for generalized tasks. In one implementation, the automation production system 104 then begins utilizing each of the individual models by tuning each model through a process of prompt tuning. Then, the AI integration system 106 can facilitate providing each model with information needed such that the models are able to perform more specialized tasks. The AI integration system 106 coordinates the entry of each of the individual models. The prompts may sometimes be referred to as tuning prompts as they allow each of the models to perform domain specific functions and which require domain specific knowledge. For example, each of the models can be provided the following types of information as prompts into a chat-based user interface. The prompts may include one or more of the user's automation program request, a role definition instruction, domain knowledge, functional instructions, guidelines, and output instructions. Depending on factors such as the specific model utilized and the specific user automation program request, various combinations of such prompts can be used to tune the model.

Role definition instructions or prompts that give each of models a point of view or role within which to set itself so the models can develop outputs or solutions as if they were actors having such points of view or roles. The domain knowledge prompts include information that the models can draw from in order to perform the functions and produce the outputs required by the user's automation program request. The functional instruction prompts include instructions as to the desired functions or actions should be taken by the model, e.g., save or copy files, send emails, or extract information from webpages, etc. Output instructions request the models to produce specific outputs that can be used to form a requested automation program or a portion thereof. Output instructions can request outputs of certain types and in certain formats or using certain programming syntax and structure.

In some implementations, output constraint instructions or prompts are also provided to each of the models. For example, such instructions may prohibit the models from producing output in certain situations, such as when certain outputs would not be suitable for use in an automation program or would not be suitable for use as an input prompt for a next model in the automation production process, when a user's request is not related to the purpose or design of the model since in such a situation the model would not be configured to address the user's request, or when the user's request is not clear such that the model would not be able to properly understand and process the user's request. Such output constraint instructions aim to minimize the degree to which large language models may produce outputs that are inaccurate, not properly pertaining to a user's request.

In some implementations, the order in which such input prompts are provided to each of the models is arranged in a certain order to increase the relevancy and accuracy of the model outputs. The order of such input prompts may vary depending on specific machine learning or large language model parameters and may vary depending upon the order, sequence, or dependency of the instructions and commands of the automation program to be produced. In some instances, the machine learning models or LLMs, sometimes referred to as production models, are provided role definition instruction, then subsequently domain knowledge, then subsequently at least one functional instruction, then subsequently output instructions, and then subsequently the user request. The input being provided can provide all at once or at different points in time. For example, one type of information subsequently provided as the input provided at different point in time may involve providing one type of instruction immediately following a preceding type of information or it may involve providing one type of information at a later point in time or at a later point in the process where other information may have been already been provided.

Each of the models can be prompted in series and some of the models could be prompted in parallel. The output produced by one model can be used as an input prompt into a next model, such that the output of a last model to be prompted will produce the automation program 206 that was requested by the user. The automation program 206 may then be loaded into the automation platform 208 where it can be executed to perform the task as desired by the user. In some cases, a user may choose to revise or further update the automation program 206 so that it is able to better complete the task.

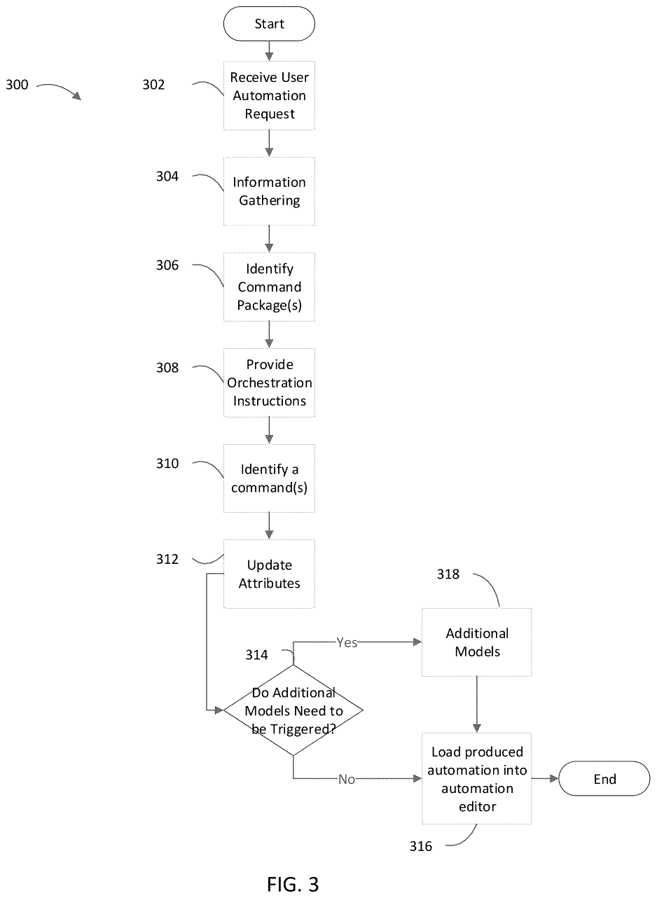

FIG. 3 illustrates an alternative implementation of an automation production process 300 according to one embodiment. The automation production process 300 can use the automation environment 100 illustrated in FIG. 1. The automation production process 300 starts when a user's request for an automation program to be produced by the automation environment 100 is received at step 302. This description of FIG. 3 involves a relatively simple user request that requires production of an automation program that is also straightforward, however, it should be understood that that users of the automation production system 104 may also request automation programs that are more complex and which would require additional models to produce additional components of automation programs. The user may enter a natural language automation request into a user interface displayed within the client device 104 such as, “add a message box and set the message to hello world.” This user may not have the coding expertise, understanding of which available command packages, commands, etc. to use in order to create an automation program to accomplish the objective of the user's request. As such, automation production system 104 can be configured to produce the automation program so that the user can more easily and more quickly automate tasks.

At information gathering step 304, the automation production system 104 performs an information gathering process regarding the current state of the automation environment 100 so that it will be able to perform the following steps of the automation production process 300. Information gathering 304 involves gathering any current automation programs that have previously been created, the command packages that are available for use by the user within the repository 112, the various commands available within each of the command packages, the version numbers of the command packages and commands, and the attributes of the commands within existing automation programs. In some automation systems, such as the automation system 102 described here, command packages are groups or bundles of commands (or actions) wherein each of the commands can be used to perform various tasks.

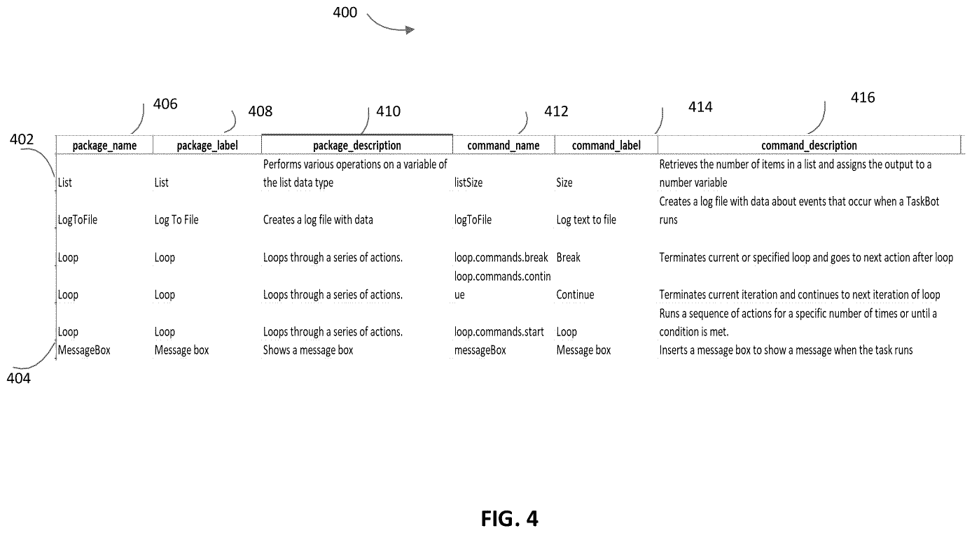

The automation production process 300 identifies one or more command packages 306 suitable for creating the user requested automation program by utilizing the command package model 114 or other machine learning or large language model. By identifying the one or more command packages, a next model can then review the packages to identify the appropriate commands within each package for executing an automation process. Continuing with the user request example above, the AI integration system 106 coordinates and effects the input of the following prompts into the command package model 114: 1) a role definition instruction, such as “You are an intelligent assistant for an automation system to help a software developer build an automation program. You are to ask the software developer to describe the automation they would like to create.”; 2) domain knowledge, such as through a prompt stating, “The software developer would like create an automation workflow by understanding which packages they would need. Here are available packages and a description of the one or more commands contained within each of the packages and the actions taken by each of the commands”, and then feeding into the model a prompt that includes a list of package names, package labels, a description of the commands contained within the packages, the names of the commands contained within each of the packages, command labels, and a description of each of the commands in terms of what functionality or actions are performed by each command. This package and command related information can be entered into the model in various formats, for example such information can be provided in a text file such as a CSV file (comma-separated values), which may be a text file version of a corresponding spreadsheet that contains the same information except in row and column format. An example of a spreadsheet 400 that lists command package and associated package information is shown in FIG. 4. For an example of what similar information looks like in text format, see here:

{“packages”: [{“package_name”: “GenerativeAI”, “description”: “do tasks related
to generative AI”, “usage”: “connect to large language models, run chat
completion and prompts on Google Vertex AI, Microsoft Azure OpenAI or
OpenAI”}, {“package_name”: “Prompt”, “description”: “ask/prompt the user for an
input”, “usage”: “prompt the user for an input value, a yes/no response, file path
or a folder path during bot execution”}, ... {“package_name”: “Message box”,
“description”: “inserts a message box that shows a text message when the task
runs”, “usage”: “display a text message during bot execution”},
{“package_name”: “Microsoft 365 Calendar”, “description”: “automate meeting
related tasks in Microsoft 365 calendar”, “usage”: “connect/disconnect,
create/cancel/modify meeting, add attachment/attendees, get available meeting
slots, respond to meeting”},

FIG. 4 illustrates a portion of a spreadsheet version of domain knowledge to be provided to a command package model, according to one embodiment. As illustrated in FIG. 4, spreadsheet 400 includes rows, such rows 402 and 404, and columns of command packages and commands. Column 406 has a column header title of “package_name” as this column includes the package name of each listed package. A package_name can be a name or identifier for use by the automation system 102 and by the command package model 114. Column 408 has a column header of package_label, which is an identifier for packages that can be more easily readable by humans, and which could be more easily recognized by large language models. Column 410 has a column header title of package_description as this column includes a description of the one or more commands that correspond to or are contained within a respective command package. Column 412 has a column header title of command_name as this column includes the name of each command in a respective row. Column 414 has a column header title of command_label which is a is an identifier for commands that can be more easily readable by humans, and which could be more easily recognized by large language models. Column 416 has a column header title of command_description as this column includes a description of each command listed in the spreadsheet 400.

Spreadsheet 400 shows that some command packages have a single command that corresponds to the command packages and other command packages can have more than one corresponding command. As can be seen, row 404 shows the package of MessageBox, which as the corresponding command with the command_name of messageBox, as seen in column 414.

The AI integration system 106 also causes one or more functional instructions to be entered into the command package model, such as “Find command packages that contain commands relevant for the requested automation program.” The wording of this and other prompts can vary so long as the objective of the instructions can be understood by the command package model.

Output instructions are also entered into the command package model 114, such as, “Put the full name of the packages needed in the “package_names” attributes of this JSON: {“package_names”: [ ]}”. Output instructions instruct the model as to the content and format of the output desired, which in this example is the name of a suggested command package name in a JSON (JavaScript Object Notation) file and syntax. In some instance, a user's request may result in the command package model in suggesting more than one command package for incorporation into the requested automation program. This may be the case for requests that may require multiple actions to be taken in order to complete a desired task to be automated. For example, when multiple packages are required, the output may be presented as: [“Message box”, “Excel”, “Email”].

In this example, output constraint instructions are also provided to the command package model 114 as follows:
It is possible that no package is suitable. In this case, fill the “package_names” attributes as NOTFOUND.
Only output the response JSON.
It is possible that the user request is not related to RPA or Automation Anywhere and therefore is invalid. If this is the case, return the following JSON: {“response”: “This is not a valid request”}

These output constraint instructions instruct the command package model 114 to set the package_names attribute value to NOTFOUND so that the automation production system 104 will be made aware that no suitable command package has been identified. This minimizes the possibilities that any erroneous output values for package names are then propagated through or used in the remaining process steps. In some implementations, a NOTFOUND value for package_name will terminate the automation production processing. Output constraint instructions also instruct the command package model 114 to produce an output only in JSON format and not in any other format since other formats will not be suitable for use in automation production system 104. Output constraint instructions also instruct the command package model 114 to provide a message to inform the user (or software developer) when an automation program request is not a valid request, in which case the automation production process may terminate or the user can provide a new request.

The command package model 114 is also provided with the user's automation program request, i.e., “add a message box and set the message to hello world.” Having been provided with the above tuning prompts, the command package model 114 provides the following output:
{“package_names”: [“Message Box”]}

This JSON output indicates the command package name identified by the command package model 114 is called Message Box. To provide this output, the model analyzed the knowledge base of the package and command list from the perspective of an intelligent assistant for an automation system and identified the Message Box package as being suitable for the user's request.

In other instances, command package model can identify more than one package for automating a user's request. For example, a user's request to read invoice amounts from a spreadsheet and then send the invoice amounts in an email. For such a request, the command package model may produce a package for reading from spreadsheet, a package for sending emails, and another package for incorporating a loop command so that multiple invoice amounts can be read from the spreadsheet. Such command packages in JSON format may resemble the following:
{“package_names”: “spreadsheet application name”, “email”, “loop” }

At step 308, automation production system 104 uses orchestration model 116, which uses automation program production guidelines to produce instructions concerning the subsequent automation production processes and which of the other individual models are needed to produce the various aspects of the requested automation program. The prompts provided to the orchestration model 116 include:
1) role definition instruction, such as “You are an intelligent assistant for an automation system”
2) provisioning of the output from the previous model, the command package model 114, by providing a prompt such as: “You have the following automation packages with which you can produce an automation: [‘Message box’]
3) provisioning of a JSON file representing any preexisting automation programs to which the user may want the requested automation program to be added to, incorporated into, or modified by. In instances where there preexisting automation programs do not exist, a place holder or “dummy” JSON file may be provisioned. Below is an example of a preexisting automation program that is provisioned to the orchestration model 116:

“{‘nodes’: [{‘uid’: ‘f1691997-6e8e-4be0-b07a-9a7bd041b536’, ‘commandName’:
‘messageBox’, ‘packageName’: ‘MessageBox’, ‘disabled’: False, ‘attributes’:
[{‘name’: ‘title’, ‘value’: {‘string’: ‘Automation Anywhere Enterprise Client’, ‘type’:
‘STRING’}}, {‘name’: ‘content’, ‘value’: {‘type’: ‘STRING’, ‘string’: ‘hello world’}},
{‘name’: ‘scrollLines’, ‘value’: {‘number’: ‘30’, ‘type’: ‘NUMBER’}}, {‘name’:
‘closeMsgBox’, ‘value’: {‘boolean’: False, ‘type’: ‘BOOLEAN’}}, {‘name’: ‘timeOut’,
‘value’: {′number’: ‘5’, ‘type’: ‘NUMBER’}}]}], ‘variables’: [{‘type’: ‘NUMBER’,
‘subtype’: ‘UNDEFINED’, ‘readOnly’: False, ‘input’: False, ‘output’: False, ‘name’:
‘SampleNumber’, ‘defaultValue’: {‘type’: ‘NUMBER’, ‘number’: ”}}, {‘type’:
‘STRING’, ‘subtype’: ‘UNDEFINED’, ‘readOnly’: False, ‘input’: False, ‘output’:
False, ‘name’: ‘SampleString’, ‘defaultValue’: {′type’: ‘STRING’, ‘string’: “}}]}”

In this example, the user may desire the requested automation program to be added to the end of the above preexisting automation program.
4) functional instructions, such as “Your task is generating automation according to the user prompt to generate automation.”
5) orchestration guidelines, provided with a prompt of: “Use the following guidelines to generate operations and return them in a JSON array” with the orchestration guidelines of:

1. If the user prompt is about to modify the node, return a JSON object in this
format: [{‘update’: ‘update the [packageName] [commandName] node
[attributeName] to [value]’}]
2. If the operation requires adding new automation to the existing bot, find the
most suitable package and generate a JSON in this format: [{‘add‘:
{‘[packageName]’: ‘[operationDescription]’, ‘containsSpecificValueForUpdate’:
‘[return 1 if operation description has a specific value that can be used in
automation, return 0 otherwise]’}}]
3. If the operation requires error handling, use the ErrorHandler package. This
package has a try-catch-finally block. Use it like this: [{‘errorHandler‘: {‘try’:
[{‘add’: {‘[packageName]’: ‘[user operation]’}}, {‘add’: {‘[packageName]’: ‘[user
operation]’}}], ‘catch’: [{‘add’: {‘[packageName]’: ‘[user operation]’}], ‘finally’:
[{‘add’: {‘[packageName]’: ‘[user operation]’}]}]
4. If the operation requires a loop, use the Loop package and put the
operations into the loop in this JSON format: {‘loop’: {‘iterator’: ‘[loopDescription]’,
‘loopType’: “[‘while’ or ‘for’]”, ‘children’: [{‘add’: {‘[packageName]’:
‘[operationDescription]’}}, {‘add’: {‘[packageName]’: ‘[operationDescription]’}}]}}
5. If the operation includes a condition, use the if package and put the
operations into the if in this JSON format: [{‘conditional’: {‘if‘: {‘condition’:
‘[condition statement]’, ‘children’: [{‘add’: {‘[packageName]’: ‘[user operation]’}}]},
‘elself’: {‘condition’: ‘[condition statement]’, ‘children’: [{‘add’: {‘[packageName]’:
‘[user operation]’}}]}, ‘else’: {‘children’: [{‘add’: {‘[packageName]’: ‘[user
operation]’}]}}}]
6. If the user prompt is about to delete an existing variable, not a node, return
a JSON object in this format: [{‘deleteVariable’: ‘[variableName]’}]
7. If the user wants to disable a node, find the node unique identifier (uid) in
the automation and return it in a JSON object in this format: [{‘disable’: {‘uid‘:
‘[uid]’}}]
8. If the operation requires deleting the automation in the existing bot, find the
node uid to delete and return it in a JSON object in this format: [{‘delete’: {‘uid’:
‘[uid]’}}]

Note that “uid” stands for unique identifier.

Orchestration guidelines allow orchestration model 116 to determine how automation programs should be produced, include the structure of the programs, depending on the specific scenarios and objectives with which the automation production system 104 is requested to produce automation programs. The guidelines also cause model triggers to be selectively set so that other individual models will be utilized as needed to produce the needed automation program aspects for the requested automation program. E.g., model triggers could be set for a loop or if command if any actions need to be repeated according to certain conditions or value settings. Although the guidelines presented above instruct the automation production system 104 to produce automation programs in JSON formats, it should be understood that the guidelines can also instruct the programs to be produced in other formats such as XML (Extensible Markup Language).
6) Output constraint instructions, such as “The described objects should not have any additional properties. Starting from the next line, return only the valid JSON array with no additional text, explanations, or comments.”
7) the user automation program request, “add a message box and set the message to hello world”.

Orchestration model operates given the above prompts and produces an output that includes instructions for producing an automation program and model triggers. Continuing with the “hello world” example, an output is as follows:

[{‘add‘: {‘Message box‘: ‘set the message to hello world‘,
‘containsSpecificValueForUpdate‘: ‘1‘}}]

The output includes an automation production instruction, a package name, an action instruction, and a model trigger. Automation production instruction in this example is the “add” instruction representing instruction to the automation production system 104 to add the requested automation program that will be produced at the end of the automation production process to the pre-existing automation program, e.g., it can be added to the end of the preexisting automation program. For different user requests, the automation production instruction, could be Update, disable, delete, deleteVariable, if and loop. The automation production instruction includes a package name, e.g., Message Box, which is the package name identified by the command package model 114 earlier in the automation production process. It should be understood that other package name or names will be included in this output depending on the package or packages identified previously.

The output also includes one or more action instructions, which in this example is, “set the message to hello world”. This action instruction is taken from the user request, but in other situations could be generated by a model based on the user request. In some instances, orchestration model 116 can interpret the users request and rephrase it when producing the prompts, information, and structure for use by subsequent models. The action instructions provide guidance to subsequent models of the AI model system 101 regarding what commands may need to be identified to produce the requested automation program. For example, when there is an if condition, the action instruction may state the action instruction type is “If” and may present the relevant type of If condition, such as “If: application running”.

The output also includes one or more model triggers which is the orchestration model's method for triggering other individual models of the AI model system as needed to produce the automation program. In this example, the model trigger is: ‘containsSpecificValueForUpdate’: ‘1’. The “1” value setting is an affirmative trigger that will cause utilization of the attributes model 120 which will then update the attribute of the Message Box package to the value to “hello world”. If the value setting were set to “0”, then the attribute model would not be triggered. Model triggers for other packages may also be set depending on the type and number of other packages identified by the command package model 114. For example, model triggers can be set for “if” command packages and loop command packages if orchestrator model determines that such command packages and commands are needed to complete the production of a requested automation program.

Orchestrator model 116 can determine the need to trigger other individual models based on the names of command packages since, in some implementations, orchestrator model will recognize certain command packages that will include commands with further automation program aspects that need to be configured. For example, if or loop command packages and their commands often have attributes that will need the attributes model 120 to suggest and configure attributes such as a condition with which to loop certain commands.

At step 310, the automation production process utilizes the command model 118 to identify a command, out of the plurality of commands associated with a command package, to be used to perform an action that is part of the requested automation program. The AI integration system 106 facilitates the input of the following prompts:
1) role definition instruction, such as “You are an intelligent assistant for an automation system”
2) domain knowledge, which includes the list of commands associated with the identified command package. From the list of commands, the command model 118 can identify one or more commands for performing actions needed by the requested automation program. In some implementations, the prompt into this model can involve providing the command package and command list that was provided as domain knowledge into the command package model. In other implementations, this prompt can be shortened to include only the commands associated with the identified command package, rather than the entire list of all command packages and commands. In this example, there is only one command associated with the Message Box command package, so the list of commands will be:

[{‘action_name’: ‘messageBox’, ‘action_description’: ‘Inserts a
message box to show a message when the task runs’}]

This list of commands includes the name of the command (or action), which in this example is messageBox, and a description of the command (or action), which in this case is “‘Inserts a message box to show a message when the task runs”. In other examples where more than one command is associated with a command package, multiple commands would be listed.
3) functional instructions to instruct the command model 118 regarding what actions it needs to take and the outputs to provide. In this example the functional instructions are:

“The user wants you to create an automation to perform the following task: “set the message to hello world”. Check action description, find a matching action that is designed to perform the task.

4) output instructions, which in this example requests the matching
command or “action_name” to be provided in a certain format as follows: “return
“action_name” in this format: {“action_name”: ””}{“action_name”: ””}”

5) output constraint instructions, such as: “Make sure the matching action is in the actions list above or If no matching action name is found, fill the action_name as NOTFOUND. Only output a valid JSON response_json without any additional text or comments.”
6) the user automation program request: “add a message box and set the message to hello world”

In this “hello world” example, the command model 118, selects the messageBox action to be the right action for “set the message to hello world”. Command model output will be provided as: {“action_name”: “messageBox”}

In step 312, automation production system 104 updates attributes of command packages and commands utilizing the attributes model 120. Various commands have attribute values that need updating in order to perform their actions. Attributes are changeable values that define the characteristics or parameters of how programming actions or commands should perform. In this example, the messageBox action attribute needs to be updated with the text to display in a message box, such as “hello world”. The AIL integration system 106 facilitates the entry of the following information in the form of prompts:
1) role definition instruction, such as “You are an intelligent assistant for an automation system”
2) domain knowledge, which includes information about the set of attributes that need to be updated for the command or commands identified by the command model. In this example, the set of attributes for the messageBox action can be prompted into the model as:

You have the following automation actions: [{‘label‘: ‘Message box‘,
‘attributes’: [{‘name’: ‘title’, ‘value’: {‘string’: ‘Automation Anywhere Enterprise Client’,
‘type’: ‘STRING’}}, {‘name’: ‘content’, ‘value’: {‘type‘: ‘TEXTAREA’, ‘textarea’: “}}, {‘name‘:
‘scrollLines’, ‘value’: {‘number’: ‘30’, ‘type’: ‘NUMBER’}}, {‘name’: ‘closeMsgBox’, ‘value’:
{‘boolean’: False, ‘type‘: ‘BOOLEAN’}}, {‘name‘: ‘timeOut’, ‘value’: {‘number’: ‘5’, ‘type’:
‘NUMBER’}}], ‘uid’: ‘f1691997-6e8e-4be0-b07a-9a7bd041b536’, ‘commandName’:
‘messageBox’, ‘packageName’: ‘MessageBox’, ‘disabled’: False}]

In some implementations, the list of attributes is a full set of possible attributes that could be set for a command. In other implementations it is possible to provide a subset of relevant attributes corresponding to a user's request. This list of command attributes can be accessed from the repository 112 of the automation system 112.
3) functional instructions, such as “Your task is to update attributes of the action that the user needs to use to automate the step.”

4) output instructions, such as “If the user wants to update a node, return
the result in this format: [{“update”: [{“targetUid”: “[uid]”, “commandName”:
“[commandName]”, “packageName”: “[packageName]”, “attributes”: [{“name”:
“[attribute_name]”, “value”: “[updated_value_object]”}]}]}]”

Additional output instructions may include:
If the updated attribute has a property named “parent_attribute_name”, take the value of “parent_attribute_name” property. Let's say this is “parent_attribute_value”.
Find the attribute in the same node that has the name “parent_attribute_value”.
Let's say this is “parent_attribute”.
Take the value of the “option_value” property. Let's say this is “option_value_value”.
Set the “parent_attribute” value to “option_value_value”.
5) output constraint instructions, such as, “If the prompt is not clear what to update, or there is nothing to update return: [{” update “: “NOTFOUND”}]. Only output a valid JSON response_json without any additional text or comments.”
6) the user automation program request: “add a message box and set the message to hello world”

In this example, the output produced by the attributes model 120 is as follows:

[{“update”: [{“targetUid”: “f1691997-6e8e-4be0-b07a-9a7bd041b536”,
“commandName”: “messageBox”, “packageName”: “MessageBox”,
“attributes”: [{“name”: “content”, “value”: {“type”: “TEXTAREA”,
“textarea”: “hello world”}}]}]}] -

This output follows the format as provided in the output instructions.

In decision step 314, automation production system 104 checks if any additional model triggers were affirmatively set by orchestration model 116. If yes, then the process flow 300 proceeds to step 318 where one or more additional individual models are utilized to configure additional aspects of the desired automation program. If no additional model triggers are affirmatively set, then process flow proceeds to step 316 where the produced JSON file can be imported into an automation editor where a user can further configure or adjust the program language of the JSON file. Such further user configuration may be desirable if the user's automation objectives have changed or if the automation system 102 provided an automation program with some aspects that may not be accurate or which may not lead to proper automation of a process. The update action instruction may identify which nodes, for example, which action or command steps, and what attributes may need to be updated. The targetUid is an identifier to uniquely identify each node.

The output of attributes model is an automation program in JSON format that represents an automation program that includes the various aspects, such as command packages, commands, and attributes, produced by the various individual models within AI model system 101. This JSON file can be input into automation system 102 and executed to automate a task as requested by the user. In this case, the automation program causes the pre-existing automation program to be updated with the messageBox command of the messageBox command package where the attribute value of the command is “hello world” such that “hello world” will be presented as part of an automated process.

In some instances of the automation production process where the automation system 102 is unable to or uncertain of the values to which attributes should be set, then such attributes may be set to null, blank, or dummy values. These attributes can then be updated or set by the user in the automation editor.

The automation production system 104 can accept user requests that require a single command package, a single command, and corresponding attributes, and is also capable of accepting more complex requests that require multiple command packages, commands and corresponding attributes.

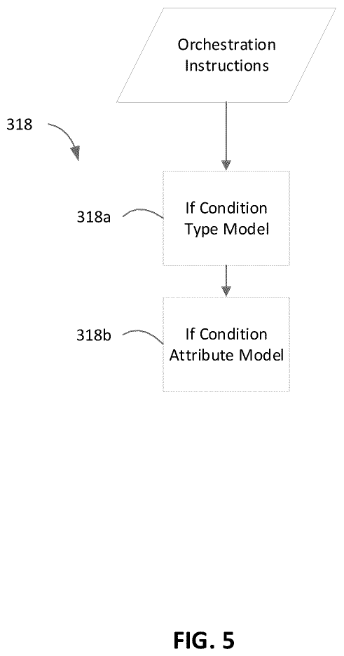

FIG. 5 is a flow diagram for utilizing models within a generative AI model system in which an orchestrator model can set affirmative model triggers, according to another embodiment. More specifically, FIG. 5 illustrates the additional machine learning or large language models within step 318 of FIG. 3, which are initiated when orchestrator model 116 sets one or more model triggers to require the additional individual models within AI model system 101 to be utilized to form the requested automation program. FIG. 5 illustrates two models for producing an automation that makes use of an if command, which performs one of two or more actions based on a certain condition or conditions. These two models are an if condition type model 318a and a condition attribute model 318b.

In other scenarios, an orchestrator model 116 may set model triggers for other models such as, but not limited to loop, addVariable, updateVariable, and other automation command related models. Each of these individual models identify or determine additional automation programming aspects so that automation production system 104 is able to produce automation programs having various and desired functionalities. Input prompts provided to each of these models will result in model outputs that provide automation program settings, configurations and structure to provide the respective command functionalities to user requested automation programs. It should be appreciated that in alternative implementations, the order of the models in step 318 may vary and the number and type of additional models may vary depending on the specific models triggered by the orchestration model.

As with the steps in FIG. 3, these additional models of FIG. 5 will similarly be provided some or all of a role definition instruction, a functional instruction, guidelines, domain knowledge, output instructions, orchestration model instructions, and a user's request for an automation program so that these individual models can produce desired outputs. As one example, the if model 318a can be provided information or prompted according to the below exemplary process.

In the case of FIG. 5, the orchestration model 116 triggers the if models in response to a user request such as, “prompt a message to $greeting$. If $greeting$ is ‘Hello’, then show ‘Hello World’ message, otherwise show ‘Good Night’ message.” This prompt may have been received by a user of the automation production system 104, such as at step 202 of FIG. 2. The orchestration model 116 identifies certain words in the user's request, such as “if”, “then”, and “otherwise” and then triggers the if models in FIG. 5. The orchestration model will then proceed to produce the instructions and guidelines for the two if models to follow in order to produce aspects of an automation that utilizes an if command. An example of orchestration instructions for the if models is as follows:

```
[
  {
  “add”: {
    “Prompt”: “prompt a message to $greeting$”,
    “containsSpecificValueForUpdate”: “0”
  }
  },
  {
  “conditional”: {
    “if”: {
    “condition”: “$greeting$ == ‘Hello‘”,
    “children”: [
      {
      “add”: {
        “Message box”: “show ‘Hello World’ message”,
        “containsSpecificValueForUpdate”: “1”
      }
      }
    ]
    },
    “else”: {
    “children”: [
      {
      “add”: {
        “Message box”: “show ‘Good Night’ message”,
        “containsSpecificValueForUpdate”: “1”
      }
      }
    ]
    }
  }
  }
]
```

The if condition type model 318a is provided with input so that it can provide output specifying the condition type for the if command. An if condition type specifies the type of condition that will determine what actions to perform. Example condition types include file types, such as if file exists, if a file was created on, before, or after certain dates, the file size, and data table types, such as if a data table contains data, the number of row, or the number of columns, and string conditions, such as if a text string has a certain value or wording. As should be understood, many different condition types exist.

An example of inputs into the if condition type model 318a includes: Inputs provided by AI integration system 106 include:

Role Definition: You are an intelligent assistant for an automation framework. Your task is to find the best option for the if condition type based on the user request.

Domain Knowledge: Here is the list of available condition types: [‘application running’, ‘application not running’, ‘boolean condition’, ‘data table empty’, ‘number of columns in datatable’, ‘number of rows in datatable’, ‘datetime condition’, ‘key exists in dictionary’, ‘value exists in dictionary’, ‘DLL session exists’, ‘DLL session does not exist’, ‘file date’, ‘file exists’, ‘file extension’, ‘file does not exist’, ‘file size’, ‘folder exists’, ‘folder does not exist’, ‘image file found in image file’, ‘image file not found in image file’, ‘image file found in window’, ‘image file not found in window’, ‘window found in image file’, ‘window not found in image file’, ‘window found in window’, ‘window not found in window’, ‘javascript successful’, ‘javascript unsuccessful’, ‘value is found in list variable’, ‘number variable condition’, ‘ping successful’, ‘ping unsuccessful’, ‘recorder object exists’, ‘recorder object does not exist’, ‘service running’, ‘service not running’, ‘string condition’, ‘task bot successful’, ‘task bot unsuccessful’, ‘VBScript successful’, ‘VBScript unsuccessful’, ‘window exists’, ‘window does not exist’, ‘window with given title exists’, ‘window with given title does not exist’]

Functional instructions: Put the most suitable condition type designed to perform this task in: “if_condition” attribute of response_json: {“if_condition”: “ ”}.

Output Instructions: Only output the response json without any additional text or comments.

Human prompt as modified by orchestration model or the if condition type model: $greeting$==‘Hello’

Modification of the human prompt transforms the request into a form more easily accepted and processed by the if condition type model.

The output of the if condition type model would be: {“if_condition”: “string condition”}, which specifies that the condition type is a string condition.

Then the if condition attribute model 318b is utilized to determine the attributes needed for the condition type selected by the if condition type model 318a. Various condition types have different condition attributes that need to be determined. If Condition Attribute model determines how to match the orchestration model instructions to appropriate if condition attributes. In this example, $greeting$ variable is the source value and the operator is equal, and the target value is Hello based on the expression of, $greeting$==‘Hello’

Inputs into the if condition attribute model 318b can be as follows:

Inputs provided by AI integration system 106 include:

Role Definition: You are an intelligent assistant for an automation
framework. The following JSON object describes an if condition: {“name“: “condition”,
“value”: {“type”: “CONDITIONAL”, “packageName”: “String”, “conditionalName”:
“stringVariable”}, “attributes”: [{“name”: “value”, “value”: {“type”: “STRING”, “string”: ””}},
{“name”: “variable”, “value”: {“type”: “STRING”, “expression”: ””}}, {“name“: “isMatch”,
“value”: {“type”: “BOOLEAN”, “boolean”: “true”}}, {“name”: “operator”, “value”: {“string”:
“<EQ/NEQ/INCLUDE/NOTINCLUDE>”}}]}

Functional Instructions: Your task is to update the attributes of the condition according to the user input.

Output instructions: Put the updated JSON object in the “response_json” attribute of the output JSON: {“response_json”: { }}.

Output constraint instructions: Output only the JSON object without any additional formatting or quotes.

### Guidelines:

1. For attributes named “operator”, choose the best matching operator from the options provided in the JSON object. Possible values are “EQ” (equals), “NEQ” (not equals), “GT” (greater than), “GTE” (greater than or equal to), “LT” (less than), “LTE” (less than or equal to), INCLUDE (contains) and NOTINCLUDE (does not contain).
2. A date condition compares a source date to a destination date. Source date attributes names start with “source”. Destination date attributes names start with “dest”. For the DateOption attributes, choose “DATETIME” if the condition refers to a date variable, or choose “FIXED VALUE” if the date is a fixed value. If you choose “FIXED VALUE”, fill out the FixedDate and the DateFormat attributes. If you choose “DATETIME”, put the variable name in the DateTime attribute.

Human prompt as modified by orchestration model or the if condition attribute model::$greeting$==‘Hello’

The output of the if condition attribute model would be:

{“if_attributes”: [{“name”: “variable”, “value”: {“type”: “STRING”,
“expression”: “$greeting$”}}, {“name”: “operator”, “value”: {“type”:
“STRING”, “string”:
“EQ”}}, {“name”: “value”, “value”: {“type”: “STRING”, “string”:
“Hello”}}, {“name”:
“matchCase”, “value”: {“type”: “BOOLEAN”, “boolean”: true}},
{“name”:
“isIgnoreCarriage”, “value”: {“type”: “BOOLEAN”, “boolean”: false}}]}

This output represents the automation produced by the if condition models in response to the user's request for an automation.

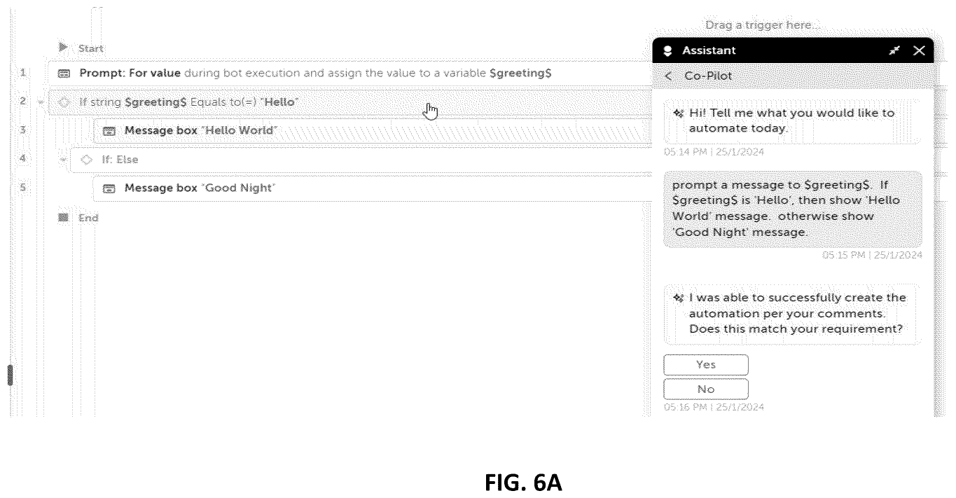

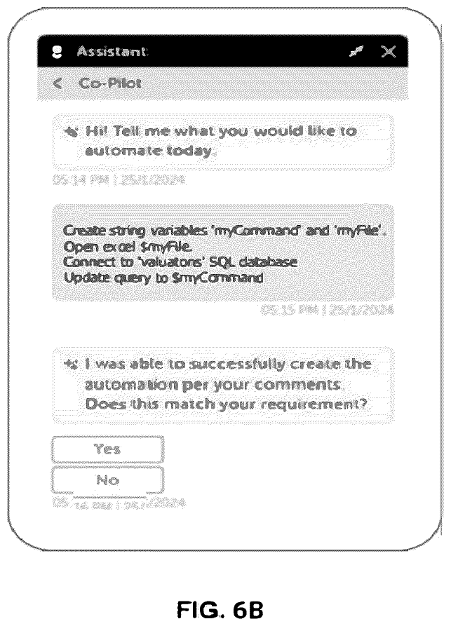

FIG. 6A illustrates an exemplary automation system user interface that includes a chat box interface where a user can enter an automation program request as well as an automation editor workspace. The resulting automation shown in FIG. 6A is a user-friendly representation of an automation output, such as the automation output by the if condition attribute model 318b.

FIG. 6B illustrates another exemplary automation system user interface that includes a chat box interface where a user can enter an automation program request. The chat box interface can also be used with the automation editor workspace shown in FIG. 6A. In this example, the instructional prompt is:
Create string variables ‘myCommand’ and ‘myFile’.
Open excel $myFile.
Connect to ‘valuations’ SQL database
Update query to $myCommand
   The resulting automation that could result from the instructional prompt provided via the chat interface is a user-friendly representation of an automation output, such as:

```
  {
    “automation”: [
    {
      “addVariable”: “create a STRING variable named
      ‘myCommand’”
    },
    {
      “addVariable”: “create a STRING variable named ‘myFile’”
    },
    {
      “add”: {
      “Excel advanced”: “open the Excel file specified by the
      variable ‘myFile‘”,
      “containsSpecificValueForUpdate”: “1”
      }
    },
    {
      “add”: {
      “Database”: “connect to the ‘valuations’ SQL database”,
      “containsSpecificValueForUpdate”: “1”
      }
    },
    {
      “add”: {
      “Database”: “update query to the command specified by the
      variable ‘myCommand’”,
      “containsSpecificValueForUpdate”: “1”
      }
    }
    ]
  }
```

The above example shows the case where the model analyzes the instruction and breaks it down into a number of tasks for various models to process. Here, an Orchestrator model is created. Then, each corresponding model (Add Variable Model, Identifier Command Model & Update Attribute Model) will execute according to the plan to generate the final automation.

In other embodiments, software automations (software automation processes) for computer-implemented tasks can be produced in a more automated fashion. Software automations can be generated in a substantially automated manner, such as without needing successive prompting. For example, from a single user request describing a desired software automation process, such as in a natural language, a software automation, or a substantial automation outline therefor, can be generated.

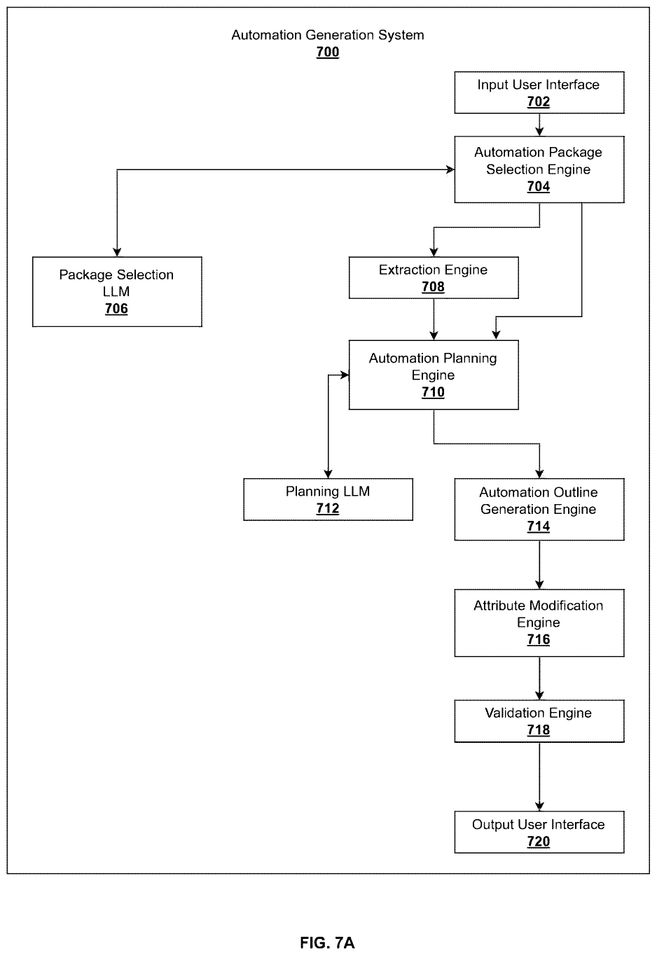

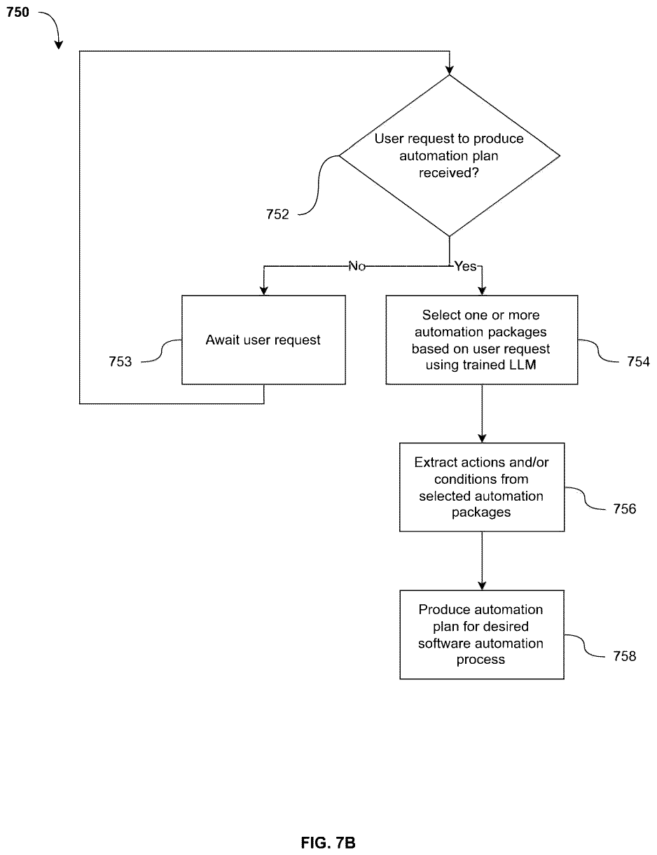

FIG. 7A is a block diagram of an automation generation system 700 according to one embodiment. The automation generation system 700 operates to generate a software automation process to carry out one or more computer-implemented tasks in an automated manner. The automation generation system 700 includes an input user interface 702 that operates to receive a user request for an automation process capable of at least partially carrying out the user's request. The user's request is, for example, a request for creation of the desired software automation process.

The desired software automation process received from the input user interface 702 can be provided to an automation package selection engine 704. The automation package selection engine 704 can interact with a package selection LLM 706. The package selection LLM 706 is trained to identify relevant automation packages for a given user request for a software automation process. The automation package selection engine 704 identifies one or more automation packages that are useful for generating the desired software automation process. In doing so, the automation package selection engine 704 is assisted by the package selection LLM 706. In one implementation, the identified automation packages are selected from a plurality of automation packages that are supported by a host RPA system.

The one or more identified automation packages identified by the automation package selection engine 704 can be provided to an extraction engine 708. The extraction engine 708 can then extract from the identified automation packages at least one or more of actions (e.g., commands), conditions (e.g., conditional statements to control program flow) and/or iterators (e.g., looping control) from the identified automation packages. The extracted actions, conditions or iterators can then be used in generating the desired software automation process.

The automation generation system 700 also includes an automation planning engine 710. The automation planning engine 710 receives the one or more identified automation packages from the automation package selection engine 704, and receives the one or more extracted actions, conditions or iterators from the extraction engine 708. The automation planning engine 710, with assistance from a planning LLM 712, can generate an automation plan. In one implementation, the automation plan being produced by the automation planning engine 710 logically organizes a plurality of the extracted actions and a plurality of the conditions, and considers variable creation, data flow and execution order.

The resulting automation plan from the automation planning engine 710 can be provided to an automation outline generation engine 714. The automation outline generation engine 714 can produce an automation outline. The automation outline from the automation outline generation engine 714 can then be provide to an attribute modification engine 716. The attribute modification engine 716 can modify the automation outline to yield a modified automation outline. In one implementation, the automation outline has placeholders for attribute values, and, in producing the modified automation outline, the attribute modification engine 716 can modify the automation outline to include attribute values in the placeholders for attribute values.

Thereafter, the modified automation outline can be provided to a validation engine 718 that performs validation of the modified automation outline, and outputs a validated automation outline. The various validations performed by the validation engine 718 can include validation(s) based on one or more of validation rules and schema constraints. The validated automation outline can then can be provided to an output user interface 720. The output user interface 720 can present the validated automation outline (such as on a display device) to a user, such as the user that initially provided the initial user request. The validated automation outline is a robust automation outline for the desired software automation process. In one implementation, the validated automation outline can be further customized, modified or processed so as to produce the desired software automation process with substantially less effort than without the assistance of the automation generation system 700.

FIG. 7B is a flow diagram of an automation plan process 750 according to one embodiment. The automation plan process 750 is, for example, processing carried out by the automation generation system 700 illustrated in FIG. 7A. More particularly, as an example, the automation plan process 750 can be carried out by the input user interface 702, the automation package selection engine 704, the package selection LLM 706, the extraction engine 708, and the automation planning engine 710 of the automation generation system 700.

In the embodiment of the automation plan process 750 illustrated in FIG. 7B, the automation plan process 750 can begin with a decision 752 that determines whether a user request to produce an automation plan has been received (or a request for a desired software automation process). When the decision 752 determines that a user request to generate an automation plan has not been received, the automation plan process 750 can await such a request.

On the other hand, when the decision 752 determines that a user request to generate an automation plan has been received, the automation plan process 750 can continue. In this regard, one or more automation packages are selected 754 based on the user request. This selection 754 can be implemented, assisted or determined using a LLM trained to recommend automation packages, such as the package selection LLM 706 illustrated in FIG. 7A.

Next, one or more actions and/or conditions supported by the selected one or more automation packages can be extracted 756 from the selected one or more automation packages. Thereafter, an automation plan for a desired software automation process can be produced 758. The automation plan being produced 758 includes a series of steps as well as includes use of one or more of the extracted actions and/or conditions supported by the selected one or more automation packages. Following the production of the automation plan, the automation plan process 750 can end, according to this embodiment.

The automation plan being produced by the automation plan process 750 is suitable for use as a partially formed software automation process. In other words, the automation plan is able to be automatically produced and then can be further processed with or without different degrees of user assistance to yield a substantially competed software automation process.

In one implementation, the automation package selection engine 704 identifies one or more automation packages based on the user's request. A database can store available automation packages and their description. The automation package selection engine 704 can analyze the user's request and seek to match with certain of the available automation packages stored in the database that are relevant to responding to the user's request. If none of the available automation packages is deemed a match, then the user can be notified that their user request is not supported by the available automation packages.

In one implementation, the extraction engine 708 can extract from the identified automation packages at least one or more of actions, conditions and/or iterators from the identified automation packages. The database can store in its descriptions details on the actions, conditions or iterators that are supported by the corresponding automation package. The extraction engine 708 can output a JSON file that identifies the matching ones of the available automation packages and also metadata for their description details (e.g., metadata).

In one implementation, the automation planning engine 710, with assistance from the planning LLM 712, can generate an automation plan from the identified automation packages that match and using their description details (e.g., metadata). The description details can, for example, denote capabilities for the corresponding automation package. The capabilities can, for example, denote those actions, conditions or iterators supported for that automation package. The automation plan can organize a plurality of the actions into a logical sequence, can make use of plurality of the conditions and/or iterators for program flow control and/or execution order, and can considers variable creation. Also, in one implementation, the automation plan can have a natural language format but arranged to facilitate later translation into a technical implementation.

In one implementation, the automation outline generation engine 714 can produce an automation outline. The automation outline can be generated from the automation plan. In generating the automation outline, the automation outline generation engine 714 can also use the identified automation packages and their description details (e.g., metadata), such as JSON schema for actions. The automation outline generation engine 714 can also make use of automation templates or structures. Also, in one implementation, the automation outline generation engine 714 in producing the automation outline can perform processing, such as one or more of: convert the automation plan into a structured format (e.g., structured automation framework suitable for attribute population); create a structured skeleton for a software automation with placeholders for attributes (e.g., JSON outline with empty attribute placeholders); and sets up nodes (e.g., with node hierarchy), connections, flow control elements, error handlers, and step-by-step output descriptions.

In one implementation, the attribute modification engine 716 can receive the automation outline having attribute placeholders. The attribute modification engine 716 can also have access to the identified automation packages and their description details (e.g., metadata), such as JSON schema for actions. Also, the attribute modification engine 716 also can also receive or have access to user-provided parameters and values. The attribute modification engine 716 can produce a modified automation outline. The modified automation outline can be a structured automation process, such as in a JSON format, with relevant attributes populated with values. Also, in one implementation, the attribute modification engine 716 in producing the modified automation outline can perform processing, such as one or more of: fill in attribute values to placeholders; apply business logic for input and output attribute population; validate attribute types and constraints; handles variable assignments and data mappings; and link file references and automation dependencies based on requested user security context.

The validation engine 718 performs validations on the modified automation outline to output a validated automation outline. For example, the validated automation outline can be a nearly complete automation process suitable for final rendering. The validated automation outline can have a JSON format. In one implementation, the validation engine 718 in producing the validated automation outline can perform processing, such as one or more of: error checking and consistency verification; information transformation on the values of the attribute, condition, and iterator to match specifications; handles variable naming conflicts and resolution; and creates variables for any required attributes having a missing value.

In one implementation, the output user interface 720 can, for example, produce a HTTP Response having status and content of the JSON formatted software automation process, and a user-friendly automation summary and documentation therefor. In one implementation, the output user interface 720 in presenting the validated automation outline can perform or result from processing, such as one or more of: generate user-friendly status, message, and action items to complete the remaining automation; create execution-ready automation with an API contract for user interface; user-friendly automation summary and documentation; and form HTTP Response with status and content of Automation JSON.

The generation of software automations is itself highly automated and assisted by artificial intelligence. An exemplary scenario for generation a software automation according to one embodiment of a software automation generation system is detailed below.

### A. Receive User Request

Initially, a user provides a request for a desired software automation. This can be done using a graphical user interface (e.g., the input user interface 702) that permits a user to enter a user request describing a desired software automation. The user request can be provided as a text entry or a voice entry. In one implementation, the user request can specify in natural language one or more computer-implemented tasks to be carried out for the desired software automation. An exemplary user request from the user might be:
Merge two spreadsheets ‘a.xlsx’ and ‘b.xlsx’ from the folder at c:\temp by using the column AccountNo. Save the result to ‘c.xlsx’. Exclude records if the CustomerName contains ‘Kevin’ or the Phone is ‘33333’.

Here, the user desires to create a software automation (e.g., bot) that can merge two spreadsheets, save the request, and also exclude certain records.

### B. Identify Relevant Automation Packages

Next, relevant automation packages for carrying out the one or more tasks of the desired software automation can be determined.

A software automation platform can be implemented to support a plurality of different packages. Examples of different packages include: Excel, Data Table, String, Email, Outlook 365, ServiceNow, Salesforce, AI Skills. Database and various others Depending on the tasks involved in the desired software automation, different packages are relevant to carry out the automation. In one implementation, those packages that are relevant can be determined by the automation package selection engine 704. As an example, the relevant packages for implementing automation of the exemplary user request might be represented by:
“package_names”: [“Excel_MS”, “DataTable”, “String”]
   Here, by evaluating the exemplary user request, the automation generation system has identified three relevant packages, namely, “Excel_MS”, “DataTable”, “String”.

The identification of those of the available packages that are relevant for processing the exemplary user request can constrain processing to likely relevant domains so as to optimize the automation generation process. Also, if no relevant packages are identified, then the exemplary user request can be denied as falling outside the domains supported by the automation generation system. In other words, the package identification can operate as a filter that helps determine whether a user request can be effectively processed by automation generation system.

Packages contain at least actions that can be utilized in automation programs. In one embodiment, a package is a collection of actions that you use and configure to build automations supported by a software automation platform. For example, a package can include one or more of: actions (also called commands); conditional statements (e.g., if-then conditions); iterators (e.g., number of times to be run); triggers (e.g., conditions that cause an automation to run); or variables (e.g., system or custom variables).

### C. Reasoning & Planning

After relevant packages have been identified, an automation plan can be constructed. The automation plan can utilize the identified packages and produce an automation plan to carry out the desired software automation. The processing to construct the automation plan can utilize artificial intelligence, such as a LLM trained to produce an automation plan for a user request and using actions supported by the identified packages.

In one embodiment, the automation plan can be constructed in accordance with the following process operations which transforms the user's original request into a structured, executable plan by:
1. Breaking down the overall task into discrete, logical steps.
2. Mapping each step to specific command actions within the available packages.
3. Converting natural language expressions into precise technical specifications.
4. Accommodating various input styles—from casual requests to technical requirements.
   This translation chain serves as a critical bridge, transforming abstract user intentions into concrete, implementable automation steps with explicitly defined actions and parameters.

As an example, the automation plan for the exemplary user request might be represented by:

### Automation Plan to Merge Two Spreadsheets and Save the Result

Step 1: Open Spreadsheet ‘a.xlsx’
   Use ‘Excel_MS:OpenSpreadsheet’ to open the spreadsheet ‘a.xlsx’ located at ‘c:\temp’.
   Assign the session name as ‘SessionA’.
Step 2: Retrieve Data from ‘a.xlsx’
   Use ‘Excel_MS:getWorksheetAsDataTable’ to retrieve the data from the first worksheet of ‘a.xlsx’ into a table variable named ‘TableA’.
   Specify the session name as ‘SessionA’.
Step 3: Close Spreadsheet ‘a.xlsx’
   Use ‘Excel_MS:CloseSpreadsheet’ to close the spreadsheet ‘a.xlsx’.
   Specify the session name as ‘SessionA’.
Step 4: Open Spreadsheet ‘b.xlsx’
   Use ‘Excel_MS:OpenSpreadsheet’ to open the spreadsheet ‘b.xlsx’ located at ‘c:\temp’.
   Assign the session name as ‘SessionB’.
Step 5: Retrieve Data from ‘b.xlsx’
   Use ‘Excel_MS:getWorksheetAsDataTable’ to retrieve the data from the first worksheet of ‘b.xlsx’ into a table variable named ‘TableB’.
   Specify the session name as ‘SessionB’.
Step 6: Close Spreadsheet ‘b.xlsx’
   Use ‘Excel_MS:CloseSpreadsheet’ to close the spreadsheet ‘b.xlsx’.
   Specify the session name as ‘SessionB’.
Step 7: Merge Data from ‘TableA’ and ‘TableB’
   Use ‘DataTable:join’ to perform an inner join on ‘TableA’ and ‘TableB’ using the column ‘AccountNo’.
   Save the result into a new table variable named ‘MergedTable’.
Step 8: Filter Records in ‘MergedTable’
   Use ‘DataTable:iteratorTableRow’ to iterate over each row in ‘MergedTable’.
   Assign the current row to a record variable named ‘TableRow’.
   Add a condition to exclude rows where:
   The CustomerName’ column contains the value ‘Kevin’ (use ‘String:stringVariable’ condition with the operator ‘Includes’).
   —OR the ‘Phone’ column equals ‘33333’ (use ‘String:stringVariable’ condition with the operator ‘Equal to’).
   If the condition is met, use ‘DataTable:deleteRow’ to delete the current row from ‘MergedTable’.
Step 9: Create a New Spreadsheet ‘c.xlsx’
   Use ‘Excel_MS:CreateSpreadsheet’ to create a new spreadsheet ‘c.xlsx’ at′c:\temp.
   Assign the session name as ‘SessionC’.
Step 10: Write Filtered Data to ‘c.xlsx’
   Use ‘Excel_MS:writeDataTableToWorksheet’ to write the data from ‘MergedTable’ into the first worksheet of ‘c.xlsx’.
   Specify the session name as ‘SessionC’.
Step 11: Save and Close ‘c.xlsx’
   Use ‘Excel_MS:SaveSpreadSheet’ to save the changes to ‘c.xlsx’.
   Specify the session name as ‘SessionC’.
   Use ‘Excel_MS:CloseSpreadsheet’ to close the spreadsheet ‘c.xlsx’.
   Specify the session name as ‘SessionC’.

### D. Constructing the Automation Framework

After the automation plan has been created, an automation framework can be established based on the automation plan. The automation framework provides a structural foundation for the desired software automation. The automation framework has a hierarchical organization. In one embodiment, the automation framework can be established by the following processing:
1. Provide a plurality of nodes, where each node in the structure represents a discrete step in the automation workflow.
2. Include metadata in each node, the metadata for each node can include one or more of:
   the package identifier;
   the specific action name;
   the corresponding plan item being implemented; and
   relevant session context information.

The automation framework can also handle nested conditional logic and/or iterative structures, including mapping out the automation's decision paths and control flow. The automation framework can serve as a skeletal framework upon which the complete automation solution is able to be developed, and can ensure proper organization before implementation details are added.

In one embodiment, a detailed view of the automation framework for the exemplary user request might be denoted in a JSON format and be represented by:

Detail View - Exemplary User Request
1 ′′′json
2{
3 “nodes”: [
4{
5 “packageName”: “Excel_MS”,
6 “commandName”: “OpenSpreadsheet”,
7 “input_instruction”: “Open the spreadsheet ‘a.xlsx’ located at ‘c:\\temp’.”,
8 “sessionName”: “SessionA”
9 }
10 {
11 “packageName”: “ErrorHandler”,
12 “commandName”: “try”,
13 “children”: [
14 {
15 “packageName”: “Excel_MS”,
16 “commandName”: “getWorksheetAsDataTable”,
17 “input_instruction”: “Retrieve the data from the first worksheet of
‘a.xlsx’ into a table variable named ‘TableA’.”,
18 “sessionName”: “SessionA”
19 }
20 ],
21 “catch”: [],
22 “finally”: [
23 {
24 “packageName”: “Excel_MS”,
25 “commandName”: “CloseSpreadsheet”,
26 “input_instruction”: “Close the spreadsheet ‘a.xlsx’.”
27 “sessionName”: “SessionA”
28 }
29 ]
30 },
31 {
32 “packageName”: “Excel_MS”,
33 “commandName”: “OpenSpreadsheet”,
34 “input_instruction”: “Open the spreadsheet ‘b.xlsx‘ located at ‘c:\\temp’.”,
35 “sessionName”: “SessionB”
36 },
37 {
38 “packageName”: “ErrorHandler”,
39 “commandName”: “try”,
40 “children”: [
41 {
42 “packageName”: “Excel_MS”,
43 “commandName”: “getWorksheetAsDataTable”,
44 “input_instruction”: “Retrieve the data from the first worksheet of
‘b.xlsx’ into a table variable named ‘TableB’.”,
45 “sessionName”: “SessionB”
46 }
47 ],
48 “catch”: [],
49 “finally”: [
50 {
51 “packageName”: “Excel_MS”
52 “commandName”: “CloseSpreadsheet”,
53 “input_instruction”: “Close the spreadsheet ‘b.xlsx’.”,
54 “sessionName”: “SessionB”
55 }
56 ]
57 },
58 {
59 “packageName”: “DataTable”,
60 “commandName”: “join”,
61 “input_instruction”: “Perform an inner join on ‘TableA’ and ‘TableB’
using the column ‘AccountNo’ and save the result into a new table
variable named ‘MergedTable’.”
62 },
63 {
64 “packageName”: “Loop”,
65 “commandName”: “loop”,
66 “loopType”: “for”,
67 “input_instruction”: “Iterate over each row in ‘MergedTable’ to filter
records.”,
68 “iterator”: {
69 “packageName”: “DataTable”
70 “iteratorName”: “iteratorTableRow”
71 },
72 “children”: [
73 {
74 “packageName”: “If”,
75 “commandName”: “if”,
76 “conditions”: [
77 {
78 “uid”: “1”,
79 “packageName”: “String”,
80 “conditionalName”: “stringVariable”
81 },
82 {
83 “uid”: “2”,
84 “packageName”: “String”,
85 “conditionalName”: “stringVariable”
86 }
87 ],
88 “condition_groups”: [
89 {
90 “uid”: “3”,
91 “connections”: {
92 “OR”: [
93 {
94 “type”: “CONDITION”,
95 “uid”: “1”
96 },
97 {
98 “type”: “CONDITION”.
99 “uid”: “2”
100 }
101 ]
102 }
103 }
104 ],
105 “root”: {
106 “OR”: [
107 {
108 “type”: “CONDITION_GROUP”,
109 “uid”: “3”
110 }
111 ]
112 },
113 “input_instruction”: “Exclude rows where ‘CustomerName‘ contains
Kevin‘ OR ‘Phone’ equals ‘33333’.”,
114 “children”: [
115 {
116 “packageName”: “DataTable”,
117 “commandName”: “deleteRow”,
118 “input_instruction”: “Delete the current row from ‘MergedTable’.”
119 }
120 ]
121 }
122 ]
123 },
124 {
125 “packageName”: “Excel_MS”,
126 “commandName”: “CreateSpreadsheet”,
127 “input_instruction”: “Create a new spreadsheet ‘c.xlsx’ at ‘c:\\temp’.”,
128 “sessionName”: “SessionC”
129 },
130 {
131 “packageName”: “ErrorHandler”,
132 “commandName”: “try”,
133 “children”: [
134 {
135 “packageName”: “Excel_MS”,
136 “commandName”: “writeDataTableToWorksheet”,
137 “input_instruction”: “Write the data from ‘MergedTable‘ into the first
worksheet of ‘c.xlsx’.”,
138 “sessionName”: “SessionC”
139 },
140 {
141 “packageName”: “Excel_MS”,
142 “commandName”: “SaveSpreadSheet”,
143 “input_instruction”: “Save the changes to ‘c.xlsx’.”,
144 “sessionName”: “SessionC”
145 }
146 ],
147 “catch”: [],
148 “finally”: [
149 {
150 “packageName”: “Excel_MS”,
151 “commandName”: “CloseSpreadsheet”,
152 “input_instruction”: “Close the spreadsheet ‘c.xlsx’.”,
153 “sessionName”: “SessionC”
154 }
155 ]
156 }
157 ]
158 }
159 ′′′

### E. Enriching the Automation Framework

After the automation framework has been constructed, the automation framework can be enriched with parameter information. In one embodiment, the automation framework can be enriched to include parameter details by the following processing:
1. Establish data flow pathways by mapping output variables from one action to input parameters of subsequent actions;
2. Handle a diverse range of attribute types including:
   Primitive data types (string, number, boolean date);
   Complex data structures (tables, dictionaries, lists, records);
   Logical constructs for conditional processing and grouping;
   Iteration mechanisms and their control parameters;
   Script content for code-based execution components; and
   AI skill integration parameters when applicable.

This detailed parameterization being performed can, for example, transform the skeletal framework of the automation framework into a fully (or partially) executable automation by specifying exactly how data moves between components, how decisions are evaluated, and/or how operations are configured throughout the entire workflow.

In one embodiment, a detailed view of the automation framework with detailed parameterization added might be denoted in a JSON format and be represented by:

The various aspects disclosed herein can be utilized with or by robotic process automation systems. Exemplary robotic process automation systems and operations thereof are detailed below.

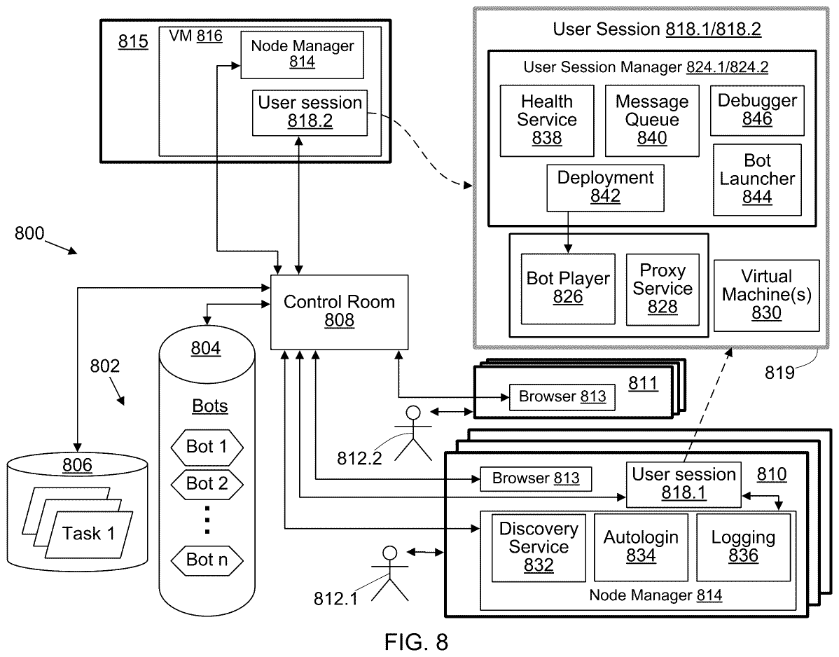

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

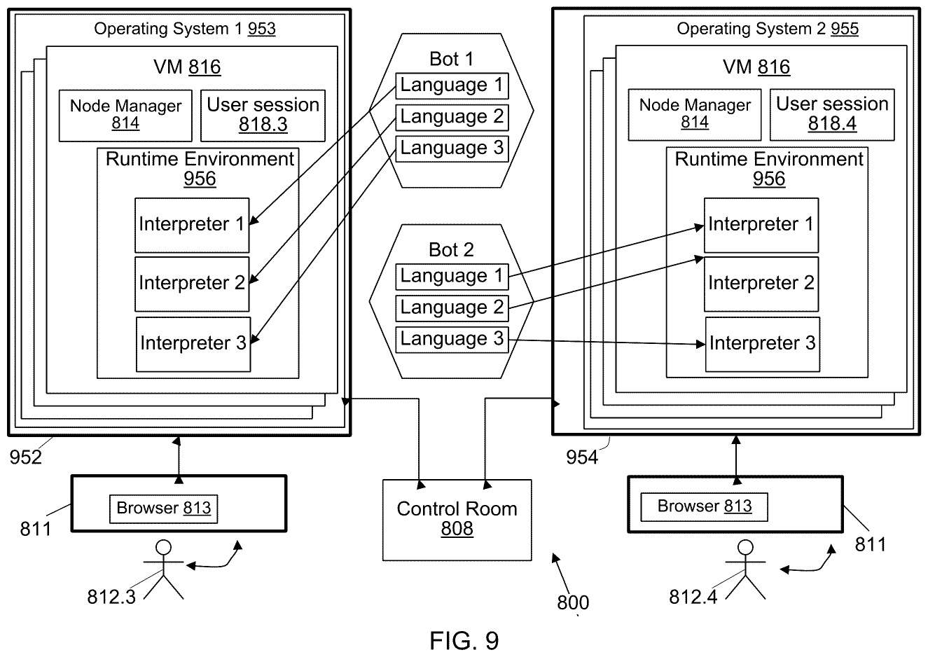

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

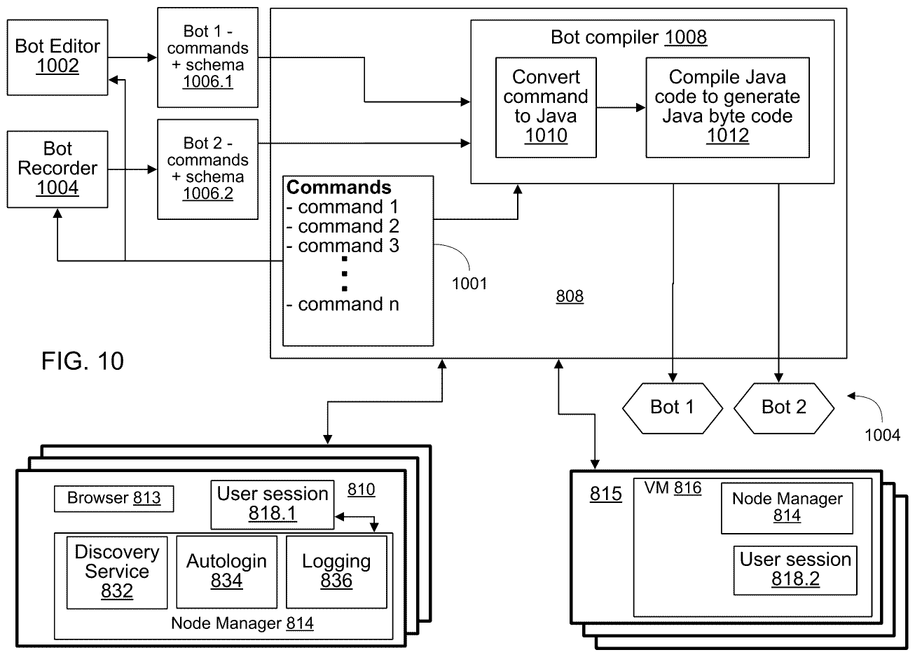

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

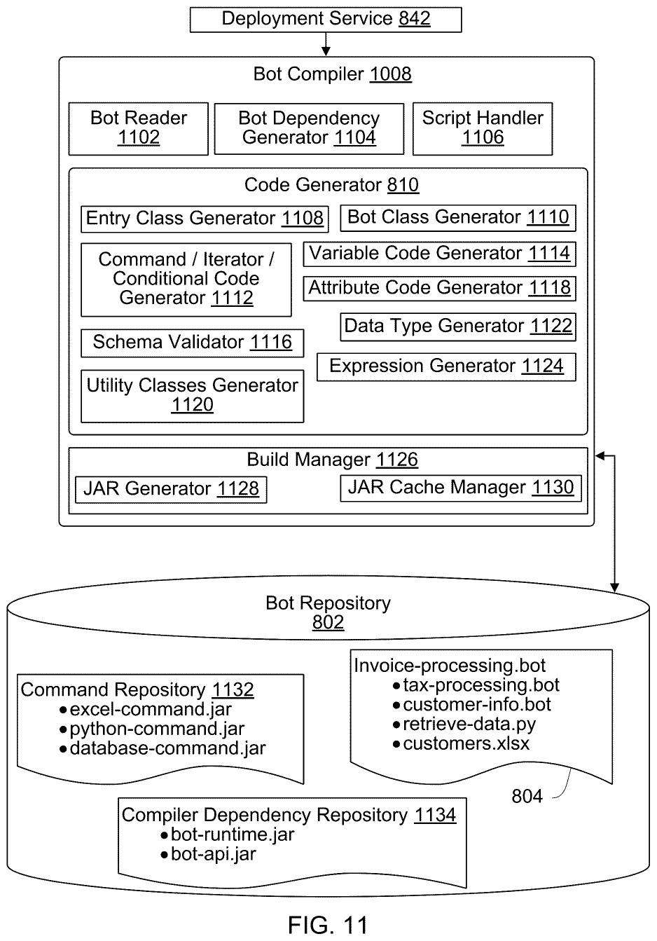

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handle the nested nature of attributes, and transform bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

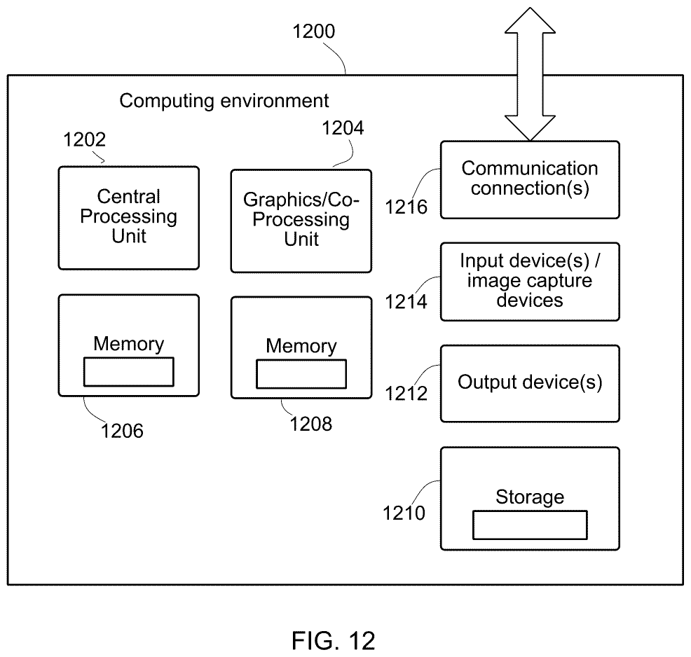

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. An automation production system for producing a software automation process for use with a robotic process automation system, the automation production system comprising:
an input user interface configured to be presented to a user and to receive a user request specifying a desired software automation process in a natural language format;
an automation package selection engine configured to use a first trained LLM to select, based on the user request, one or more automation packages from a plurality of automation packages available for user with the robotic process automation system;
an extraction engine configured to extract one or more actions, conditions and/or iterators from the selected one or more automation packages; and
an automation planning engine configured to use a second trained LLM to produce an automation plan for the desired software automation process.

2. An automation production system as recited in claim 1, wherein the automation plan being produced by the automation planning engine logically organizes a plurality of the extracted actions and a plurality of the extracted conditions, and considers variable creation, data flow and execution order.

3. An automation production system as recited in claim 1, wherein the automation plan being produced by the automation planning engine includes a series of steps.

4. An automation production system as recited in claim 1, wherein the automation plan being produced by the automation planning engine has a natural language format.

5. An automation production system as recited in claim 1, wherein the automation production system comprises:
an automation outline generation engine configured to receive the automation plan and to produce an automation outline having a structured automation framework.

6. An automation production system as recited in claim 5, wherein the structured automation framework has a JSON format.

7. An automation production system as recited in claim 5, wherein the structured automation framework includes a plurality of nodes arranged in a hierarchy.

8. An automation production system as recited in claim 5, wherein the automation outline includes attribute placeholders for the extracted actions within the automation outline.

9. An automation production system as recited in claim 8, wherein the automation production system comprises:
an attribute modification engine configured to modify the automation outline to include attribute values in the attribute placeholders.

10. An automation production system as recited in claim 9, wherein the automation production system comprises:
a validation engine configured to validate the automation outline based on validation rules and schema constraints.

11. An automation production system as recited in claim 8, wherein the automation plan and/or the automation outline being produced by the automation planning engine logically organizes a plurality of the extracted actions and a plurality of the extracted conditions, and considers variable creation, data flow and execution order.

12. An automation production system as recited in claim 11, wherein the automation production system comprises:
an attribute modification engine configured to modify the automation outline to include attribute values in the attribute placeholders.

13. An automation production system as recited in claim 11, wherein the automation plan being produced by the automation planning engine includes a series of steps.

14. An automation production system as recited in claim 13,
wherein the structured automation framework has a JSON format, and
wherein the structured automation framework includes a plurality of nodes arranged in a hierarchy.

15. A computer-implemented method for producing a software automation process for use with a robotic process automation system, the method comprising:
receiving, by an automation production system, a user request specifying a desired software automation process in a natural language format;
selecting, with the assistance of a first trained LLM and based on the user request, one or more automation packages from a plurality of automation packages available for user with the robotic process automation system;
extracting actions and conditions from the selected one or more automation packages; and
producing, with the assistance of a second trained LLM, an automation plan for the desired software automation process, the automation plan specifies a series of steps, and one or more of the steps utilizing at least one of the extracted actions, and one or more of the steps utilizing at least one of the extracted conditions.

16. A computer-implemented method as recited in claim 15, wherein the automation plan being produced by the automation planning engine logically organizes a plurality of the extracted actions and a plurality of the extracted conditions, and considers variable creation, data flow and execution order.

17. A computer-implemented method as recited in claim 15, wherein at least a plurality of the steps of the automation plan have a natural language format.

18. A computer-implemented method as recited in claim 15, wherein the method comprises:
generating an automation outline having a structured automation framework from the automation plan.

19. A computer-implemented method as recited in claim 18, wherein the structured automation framework includes a plurality of nodes arranged in a hierarchy.

20. A computer-implemented method as recited in claim 19, wherein the structured automation framework has a JSON format.

21. A computer-implemented method as recited in claim 18,
wherein the automation outline includes attribute placeholders for one or more actions within the automation outline, and
wherein the method comprises:
modifying the automation outline to include attribute values in the attribute placeholders.

22. A non-transitory computer readable medium including at least computer program code tangible stored therein for producing a software automation process for use with a robotic process automation system, the computer readable medium comprising:
computer program code for receiving a user request specifying a desired software automation process in a natural language format;
computer program code for selecting, with the assistance of a first trained LLM and based on the user request, one or more automation packages from a plurality of automation packages available for user with the robotic process automation system;
computer program code for identifying actions and conditions supported by the selected one or more automation packages; and
computer program code for producing, with the assistance of a second trained LLM, an automation plan for the desired software automation process, the automation plan specifies a series of steps, and one or more of the steps utilizing at least one of the identified actions, and one or more of the steps utilizing at least one of the identified conditions.
